(19) United States
(12) Patent Application Publication
(10) Pub. No.: US 2023/0081931 A1
(43) Pub. Date: Mar. 16, 2023

(54) HARVESTING METHOD AND HARVESTING DEVICE

(71) Applicant: Panasonic Intellectual Property Management Co., Ltd., Osaka (JP)

(72) Inventors: RYOU TOSHIMA, Nara (JP); HIDEKAZU ARAKI, Osaka (JP); SEIJI NISHITANI, Kyoto (JP)

(21) Appl. No.: 17/821,491

(22) Filed: Aug. 23, 2022

(30) Foreign Application Priority Data
Sep. 10, 2021 (JP) 2021-147542

(51) Int. Cl. A01D 46/30; G06V 20/68; G06T 7/70; A01D 46/253

(52) U.S. Cl. CPC A01D 46/30; G06V 20/68; G06T 7/70; A01D 46/253

(57) ABSTRACT

A harvesting method performed by a harvesting device including an imaging unit, includes: by the harvesting device, determining, based on a first image imaged by the imaging unit during movement of the harvesting device, whether fruit is present; stopping the movement in a case of determining that the fruit is present, and determining whether target fruit to be harvested is present in the fruit; and harvesting the target fruit, in a case of determining that the target fruit is present.

### BACKGROUND

### 1. Technical Field

The present disclosure relates to a harvesting method and a harvesting device.

### 2. Description of the Related Art

In the related art, as a device that harvests fruits, for example, a harvesting device disclosed in Japanese Patent No. 2813697 (Patent Literature 1) is known. The harvesting device according to Patent Literature 1 processes an image obtained by an imaging unit to obtain a specific color region corresponding to a color of fruit as a harvesting target and a highlight region in which brightness is larger than a set value in the specific color region. When a plurality of highlight regions are detected in the same specific color region, the harvesting device obtains virtual regions having a predetermined shape inscribed in a contour of the specific color region centered on each highlight region, and estimates that these virtual regions are specific color regions corresponding to respective highlight regions, that is, regions corresponding to fruit, thereby detecting the fruit as the harvesting target.

### CITATION LIST

### Patent Literature

PTL 1: Japanese Patent No. 2813697

### SUMMARY

A harvesting method according to an aspect of the present disclosure is a harvesting method performed by a harvesting device including an imaging unit, including: by the harvesting device, determining, based on a first image imaged by the imaging unit during movement of the harvesting device, whether fruit is present; stopping the movement in a case of determining that the fruit is present, and determining whether target fruit to be harvested is present in the fruit; and harvesting the target fruit in a case of determining that the target fruit is present.

A harvesting device according to an aspect of the present disclosure is a harvesting device configured to be movable, including: an imaging unit; an end effector; and a control unit, in which the control unit is configured to determine, based on a first image imaged by the imaging unit during movement of the harvesting device, whether fruit is present, stop the movement of the harvesting device in a case of determining that the fruit is present, and determine whether target fruit to be harvested is present in the fruit, and control the end effector so as to harvest the target fruit in a case of determining that the target fruit is present.

### BRIEF DESCRIPTION OF THE DRAWINGS

FIG. 1 is a schematic diagram showing a form of fruit;

FIG. 2 is a schematic diagram of a harvesting device;

FIG. 3 is a flowchart of a harvesting method of harvesting target fruit;

FIG. 4 is diagram of parallax between a plurality of first images; and

FIG. 5 is a schematic diagram showing coordinates of a tuft as a detection target in an XY coordinate system set in the first image.

### DETAILED DESCRIPTIONS

An object of the present disclosure is to provide a harvesting method and a harvesting device capable of improving harvesting efficiency of fruits.

### EMBODIMENT

The embodiment of the present disclosure will be described.

<Form of Fruit>

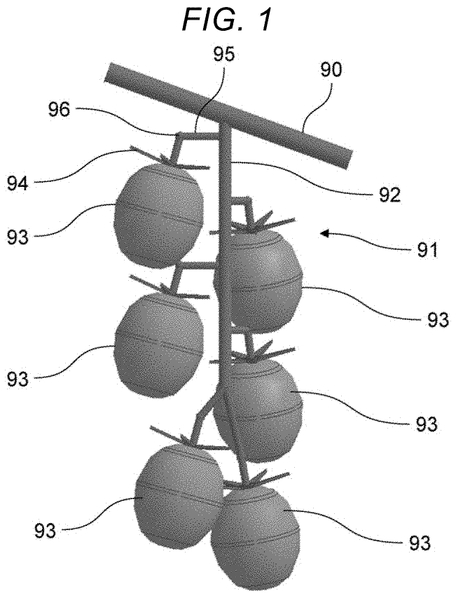

First, a form of fruit as a harvesting target in the embodiment of the present disclosure will be described. In the present embodiment, tomatoes are exemplified as the fruit, but other fruits such as strawberries, blueberries, and raspberries may be used. FIG. 1 is a schematic diagram showing a form of the fruit.

As shown in FIG. 1, tuft 91 branched from main stem 90, which is an example of a branch, hangs down due to its own weight or the like. Tuft 91 has fruit stem 92. A plurality of fruits 93 grow around fruit stem 92. Fruit 93 has calyx 94. Calyx 94 is connected to fruit stem 92 via small fruit stem 95, which is an example of a fruit stalk. Release layer 96 is a special cell layer formed between main stem 90 and an axis of fruit 93. Release layer 96 is a portion that is located in the middle of small fruit stem 95 and can be relatively easily separated by a pulling force or the like.

<Configuration of Harvesting Device>

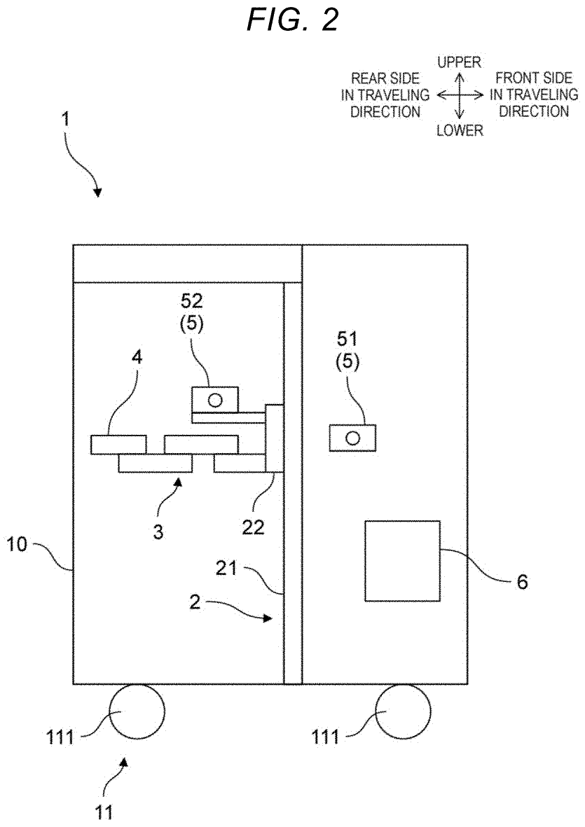

Next, the configuration of the harvesting device will be described. FIG. 2 is a schematic diagram of the harvesting device.

Harvesting device 1 shown in FIG. 2 harvests fruit 93 as the harvesting target (hereinafter, sometimes referred to as “harvesting target fruit 93”) located on a near side of a paper surface of FIG. 2 while moving to a right side in FIG. 2. An upper side is the upper side when harvesting device 1 is performing harvesting, and a lower side is an opposite side of the upper side. A front side of harvesting device 1 is the near side of the paper surface of FIG. 2, and a back side is a far side of the paper surface of FIG. 2. A left-right direction in FIG. 2 may be referred to as a traveling direction. A right side and a left side in FIG. 2 may be referred to as a front side in the traveling direction and a rear side in the traveling direction, respectively. Harvesting device 1 includes main body 10 and traveling portion 11.

Traveling portion 11 includes wheels 111 for moving main body 10, a motor, a motor driver, and the like (not shown). Traveling portion 11 moves main body 10 forward in the traveling direction, for example, along a rail (not shown) disposed between ridges of a farm.

Main body 10 is formed in a box shape. Elevating mechanism 2, work arm 3, end effector 4, imaging unit 5, and control unit 6 are disposed inside main body 10.

Elevating mechanism 2 is fixed to a center of main body 10 in the traveling direction. Elevating mechanism 2 includes guide shaft 21 extending in an upper-lower direction. Slider 22 that moves up and down along guide shaft 21 by driving of an elevating drive unit (not shown) is disposed at a portion of the guide shaft 21 on the rear side in the traveling direction.

One end side (base end side) of work arm 3 is fixed to slider 22. Work arm 3 has an arm position control mechanism (not shown) for controlling a position of the other end side (tip end side) of work arm 3 in a direction parallel to a horizontal plane.

End effector 4 is mounted on a tip end of work arm 3. End effector 4 has a function of separating fruit 93 from small fruit stem 95. As end effector 4 having such a function, for example, as disclosed in Japanese Patent Unexamined Publication No. 2017-051104, a configuration may be applied in which fruit 93 is separated from small fruit stem 95 by positioning small fruit stem 95 inside an upper harvesting ring and a lower harvesting ring and moving the upper harvesting ring relative to the lower harvesting ring. As end effector 4, a configuration in which small fruit stem 95 is cut by a cutting blade may be applied.

Imaging unit 5 includes first imaging unit 51 and second imaging unit 52.

First imaging unit 51 is used to detect tuft 91 including fruit 93 as a harvest candidate. First imaging unit 51 is fixed to a front side in the traveling direction with respect to elevating mechanism 2 in main body 10 and at a center in the upper-lower direction. First imaging unit 51 images a front side of harvesting device 1 to generate a first image. The first image is a color image of red, green, blue (RGB) obtained by reflection of sunlight.

Second imaging unit 52 is used to detect harvesting target fruit 93 from an inside of tuft 91. Second imaging unit 52 is fixed to slider 22 above work arm 3. Second imaging unit 52 includes an infrared light source (not shown) that emits infrared light. Second imaging unit 52 images the front side of harvesting device 1 to generate a second image. The second image includes an RGB color image obtained by reflection of sunlight and an infrared (IR) image obtained by reflection of infrared light from an infrared light source.

Control unit 6 is disposed, for example, on the front side in the traveling direction in main body 10. Control unit 6 harvests fruit 93 based on the first image imaged by first imaging unit 51 and the second image imaged by second imaging unit 52.

<Operation of Harvesting Device>

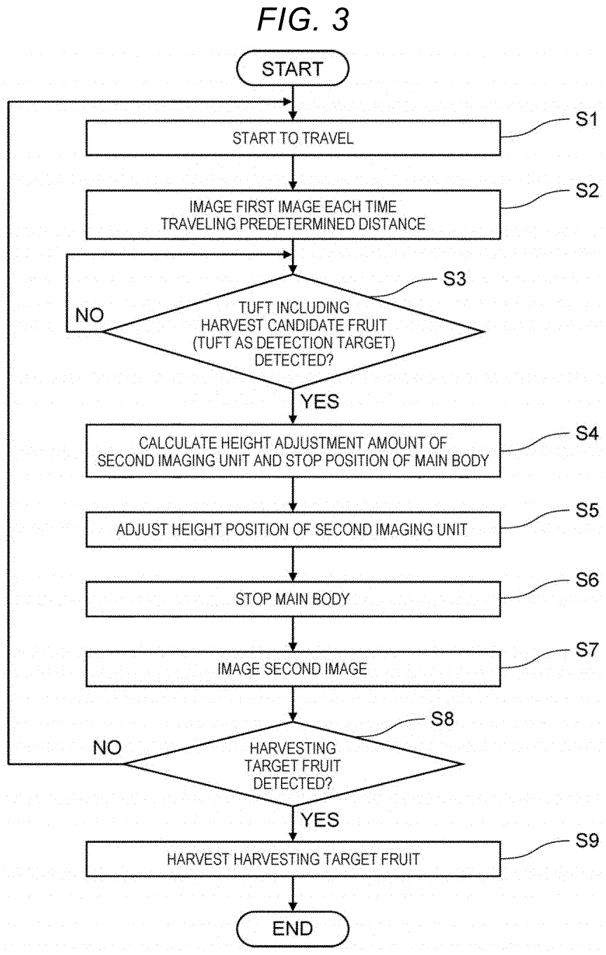

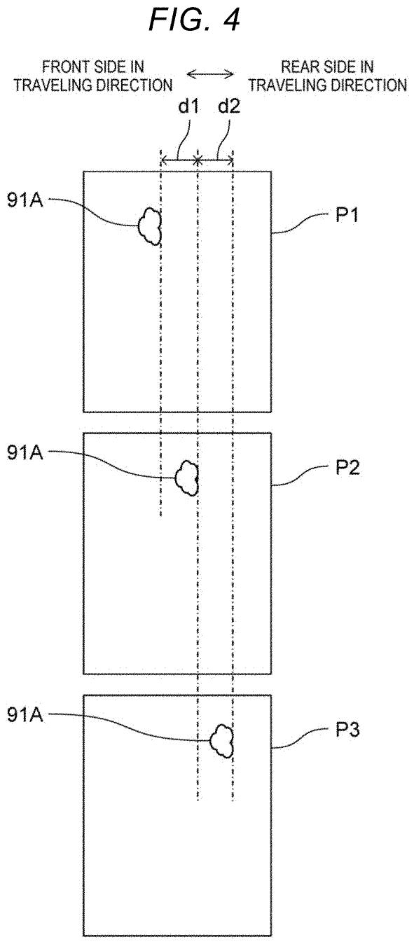

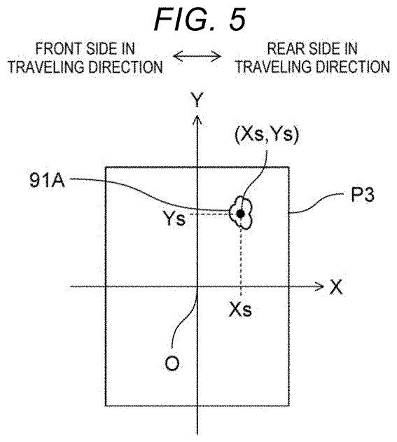

Next, a harvesting method of fruit will be described as an operation of harvesting device 1. FIG. 3 is a flowchart of a harvesting method of harvesting target fruit. FIG. 4 is diagram of parallax between a plurality of first images. FIG. 5 is a schematic diagram showing coordinates of a tuft as a detection target in an XY coordinate system set in the first image.

First, as shown in FIG. 3, traveling portion 11 starts to move main body 10 forward in the traveling direction under control of control unit 6 (step S1). Next, first imaging unit 51 images, based on the control of control unit 6, the first image each time main body 10 travels a predetermined distance (step S2). For example, first imaging unit 51 images the first image each time main body 10 travels 100 mm. Control unit 6 determines, based on the first image, whether tuft 91 including fruit 93 as the harvest candidate (hereinafter, may be referred to as “tuft 91A as the detection target”) is detected (step S3).

In step S3, control unit 6 selects a predetermined first image as a detection image from the first images imaged by first imaging unit 51, and converts a color expression of the detection image into a hue expression. Control unit 6 detects a region having a hue representing fruit 93 and having an area of a certain value or more in the detection image as tuft 91A as the detection target. In the present embodiment, since the fruit is a red tomato, control unit 6 detects a region having a hue of 0° or more and 50° or less and having an area of a certain value or more as tuft 91A as the detection target.

When it is determined that tuft 91A as the detection target is not detected (step S3: NO), control unit 6 newly selects, as a detection image, the first image imaged next to the detection image used for the determination, and determines, based on the newly selected detection image, whether tuft 91A as the detection target is detected (step S3). On the other hand, when it is determined that tuft 91A as the detection target is detected (step S3: YES), control unit 6 calculates a height adjustment amount of second imaging unit 52 and a stop position of main body 10 based on the first image (step S4).

In step S4, first, control unit 6 selects a plurality of first images that are the first images in which tuft 91A as the detection target is imaged and that are continuously imaged. Next, control unit 6 calculates parallax d (unit: pixel (pix)) between two first images continuously imaged. For example, as shown in FIG. 4, control unit 6 selects three first images P1, P2, and P3. First image P1 is an image imaged before first image P2, and first image P2 is an image imaged before first image P3. Control unit 6 calculates, as the parallax d, an average value of movement amount d1 of tuft 91A as the detection target in first image P1 and first image P2 and movement amount d2 of tuft 91A as the detection target in first image P2 and first image P3.

Next, control unit 6 calculates distance R(x) (mm) from first imaging unit 51 to tuft 91A as the detection target based on a following Equation (1).

R(x)=(B×f)/(d×cellsz) (1)

R(x) is a distance from first imaging unit 51 to tuft 91A as the detection target, and is a distance in a direction orthogonal to the traveling direction and parallel to the horizontal plane;

B is base line length (mm) of first imaging unit 51;

f is a distance from a center of a lens of first imaging unit 51 to a light receiving device (mm);

d is parallax (pix) between two continuous first images; and

cellsz is a size of one pixel of the light receiving device (mm/pix).

Next, control unit 6 calculates distance R(y) in the traveling direction of second imaging unit 52 and distance R(z) in the upper-lower direction of second imaging unit 52 based on the first image in which tuft 91A as the detection target is imaged. First, as shown in FIG. 5, control unit 6 sets the XY coordinate system in which a center of the latest first image (for example, first image P3) in which tuft 91A as the detection target is imaged is origin O of coordinates and units of an X axis and a Y axis are the number of pixels of the first image. When the number of pixels in an X-axis direction (horizontal direction) of the first image is 960 and the number of pixels in a Y-axis direction (vertical direction) of the first image is 1280, control unit 6 calculates distance R(y) (mm) in the traveling direction and distance R(z) (mm) in the upper-lower direction based on coordinates (Xs, Ys) indicating position of tuft 91A as the detection target in the first image and following Equations (2), (3), and (4).

R(y)=(Xs−480)×D (2)

R(z)=(Ys−640)×D (3)

D=0.002×R(x)−0.1 (4)

D is a resolution of first imaging unit 51 when the distance from first imaging unit 51 to tuft 91A as the detection target is R(x).

Next, control unit 6 calculates the height adjustment amount of second imaging unit 52 based on a position in a height direction of second imaging unit 52 with respect to first imaging unit 51 and distance R(z) in the upper-lower direction. The height adjustment amount is a movement amount of second imaging unit 52 for positioning tuft 91A as the detection target at a center in a height direction of an imaging range of second imaging unit 52.

Control unit 6 calculates the stop position of main body 10 based on a position of second imaging unit 52 with respect to first imaging unit 51 in the traveling direction, distance R(y) in the traveling direction, and a position of main body 10 at the time of imaging the first image used for calculating distance R(y) in the traveling direction. The stop position is a stop position of main body 10 for positioning tuft 91A as the detection target at a center in a traveling direction of an imaging range of second imaging unit 52.

As shown in FIG. 3, upon completion of the processing of step S4, control unit 6 controls elevating mechanism 2 to adjust a height position of second imaging unit 52 (step S5). Elevating mechanism 2 raises or lowers second imaging unit 52 by the height adjustment amount calculated in step S4 during movement of main body 10. By the processing of step S5, tuft 91A as the detection target is located at the center in the height direction of the imaging range of second imaging unit 52.

Next, control unit 6 controls traveling portion 11 to stop main body 10 (step S6). Traveling portion 11 stops main body 10 at the stop position calculated in step S4. By the processing of step S6, tuft 91A as the detection target is located at a center in the left-right direction of an imaging range of second imaging unit 52.

By the processing of steps S5 and S6 described above, tuft 91A as the detection target is located at the center of the imaging range of second imaging unit 52. That is, second imaging unit 52 is located substantially in front of tuft 91A as the detection target.

Next, second imaging unit 52 images a second image under the control of control unit 6 (step S7). Control unit 6 determines, based on the second image, whether harvesting target fruit 93 is detected from tuft 91 as the detection target (step S8). In step S8, control unit 6 can detect harvesting target fruit 93 using, for example, a method disclosed in Japanese Patent Unexamined Publication No. 2018-206015.

Here, a detection processing of the harvesting target fruit 93 based on the method disclosed in Japanese Patent Unexamined Publication No. 2018-206015 will be described. First, control unit 6 converts a color expression of the RGB color image forming the second image into a hue expression. Control unit 6 detects a bright spot from an IR image. At this time, a fruit portion bright spot and a main stem portion bright spot are mainly detected as the bright spot. The fruit portion bright spot is a place where luminance is increased by reflection of infrared light at a convex portion of fruit 93. The main stem portion bright spot is a place where fruit stem 92 of tuft 91 that grows on main stem 90 is cut off, and luminance is increased by reflection of infrared light.

Next, control unit 6 acquires information on a hue of a predetermined region centered on a position corresponding to the bright spot in the image converted into the hue expression, and calculates a dispersion value of the hue based on the information.

A region corresponding to red fruit 93 has a high frequency of red as the hue. A region corresponding to green fruit 93 has a high frequency of green as the hue. Therefore, in both cases of red fruit 93 and green fruit 93, the region corresponding to the fruit portion bright spot has a small variation in a distribution of color frequencies and a small dispersion value.

On the other hand, main stem 90 includes red and blue color components in addition to a green color component. In particular, a cut portion after cutting off fruit stem 92 is discolored to white or brown, and contains many red and blue color components in addition to the green color component. Therefore, a region corresponding to the main stem portion bright spot has a large variation in a distribution of color frequencies and a large dispersion value.

Next, control unit 6 determines whether a dispersion value of a hue of a region corresponding to the bright spot is less than a threshold value. When it is determined that the dispersion value is less than the threshold value, control unit 6 determines that the bright spot is a bright spot of fruit 93, and when it is determined that the dispersion value is the threshold value or more, control unit 6 determines that the bright spot is a bright spot other than that of fruit 93.

Control unit 6 determines whether a hue of a region corresponding to the bright spot determined to be the bright spot of fruit 93 (hereinafter, may be referred to as “fruit corresponding region”) indicates a color of the harvesting target. For example, control unit 6 determines whether the hue of the fruit corresponding region indicates a color of ripe harvesting target fruit 93. When it is determined that the hue of the fruit corresponding region indicates the color of the harvesting target, control unit 6 determines that harvesting target fruit 93 is present in the fruit corresponding region. On the other hand, when it is determined that the hue of the fruit corresponding region does not indicate the color of the harvesting target, control unit 6 determines that harvesting target fruit 93 is not present in the fruit corresponding region. Control unit 6 determines whether harvesting target fruit 93 is present in the fruit corresponding region corresponding to all bright spots determined to be bright spots of fruit 93.

When it is determined that harvesting target fruit 93 is not detected from tuft 91 as the detection target (step S8: NO), control unit 6 controls traveling portion 11 to start moving main body 10 forward in the traveling direction (step S1). On the other hand, when control unit 6 determines that harvesting target fruit 93 is detected from tuft 91 as the detection target (step S8: YES), control unit 6 controls work arm 3 and end effector 4 to harvest harvesting target fruit 93 by end effector 4 (step S9).

As described above, harvesting device 1 determines whether harvest candidate fruit 93 is present based on the first image imaged by imaging unit 5 during movement of harvesting device 1, and when it is determined that harvest candidate fruit 93 is present, harvesting device 1 stops and determines whether harvesting target fruit 93 is present in harvest candidate fruit 93. When it is determined that harvesting target fruit 93 is present, harvesting device 1 harvests harvesting target fruit 93 by end effector 4. Thus, by determining presence or absence of harvest candidate fruit 93 during movement of harvest device 1, harvesting target fruit 93 can be found early, and harvesting efficiency for harvesting target fruit 93 can be improved.

A harvesting method performed by harvesting device 1 includes processing of determining the presence or absence of harvest candidate fruit 93 (hereinafter, sometimes referred to as “rough recognition processing”) and processing of determining the presence or absence of harvesting target fruit 93 (hereinafter, sometimes referred to as “precise recognition processing”). In the rough recognition processing, it is sufficient to distinguish between fruit 93 and a fruit other than fruit 93, so that image recognition accuracy in the rough recognition processing does not have to be high. On the other hand, in the precise recognition processing, since it is necessary to distinguish between fruit 93 that is not harvesting target and the harvesting target fruit 93, it is necessary to increase image recognition accuracy in the precise recognition processing. Since harvesting device 1 according to the present embodiment performs the rough recognition processing during movement of harvesting device 1, it is possible to efficiently find harvest candidate fruit 93. As a result, the harvesting efficiency for harvesting target fruit 93 can be improved.

Harvesting device 1 performs the precise recognition processing based on the second image imaged by imaging unit 5 after harvesting device 1 stops. Therefore, the precise recognition processing can be performed with high accuracy based on the second image imaged after harvesting device 1 stops and having less blur.

Harvesting device 1 determines an imaging position of the second image based on the first image during movement of harvesting device 1. Therefore, it is possible to shorten a time from the stop of harvesting device 1 to start of imaging by second imaging unit 52, and it is possible to improve the harvesting efficiency for harvesting target fruit 93. In particular, by adjusting the height position of second imaging unit 52 during movement of harvesting device 1, the harvesting efficiency for harvesting target fruit 93 can be further improved.

[Modification of Embodiment]

It is needless to say that the present disclosure is not limited to the embodiment described above, and various modifications can be made without departing from the gist of the present disclosure. The above embodiment and the modification described below may be combined in any manner as long as they function normally.

For example, the rough recognition processing may be performed based on the RGB color image contained in the second image without providing first imaging unit 51. In this case, the RGB color image contained in the second image corresponds to the first image of the present disclosure.

Without providing second imaging unit 52, first imaging unit 51 may be provided with a function capable of imaging an RGB color image and an IR image, and the precise recognition processing may be performed based on the RGB color image and the IR image imaged by first imaging unit 51 during movement of harvesting device 1. In this case, the RGB color image imaged by first imaging unit 51 corresponds to the first image of the present disclosure, and the RGB color image and the IR image correspond to the second image of the present disclosure.

The imaging position of the second image may be determined after harvesting device 1 is stopped, or adjustment of the height position of second imaging unit 52 may be determined after harvesting device 1 is stopped.

According to the harvesting method and the harvesting device of the present disclosure, it is possible to improve the harvesting efficiency for fruits.

### INDUSTRIAL APPLICABILITY

The present disclosure is applicable to a harvesting method and a harvesting device.

What is claimed is:

1. A harvesting method performed by a harvesting device including an imaging unit, the harvesting method comprising:
by the harvesting device,
determining, based on a first image imaged by the imaging unit during movement of the harvesting device, whether fruit is present;
stopping the movement in a case of determining that the fruit is present, and
determining whether target fruit to be harvested is present in the fruit; and
harvesting the target fruit in a case of determining that the target fruit is present.

2. The harvesting method of claim 1, further comprising:
by the harvesting device,
determining, based on a second image imaged by the imaging unit after movement of the harvesting device is stopped, whether the target fruit is present in the fruit.

3. The harvesting method of claim 2, wherein the imaging unit includes a first imaging unit configured to image the first image and a second imaging unit configured to image the second image.

4. The harvesting method of claim 3, further comprising:
by the harvesting device,
determining, based on the first image, an imaging position at which the second imaging unit is to be positioned when imaging the second image during movement of the harvesting device.

5. The harvesting method of claim 4, further comprising:
by the harvesting device,
performing processing of adjusting a height position of the second imaging unit such that the second image is imaged at the imaging position during movement of the harvesting device.

6. The harvesting method of claim 1, wherein the fruit is a tomato.

7. A harvesting device configured to be movable, the harvesting device comprising:
an imaging unit;
an end effector; and
a control unit,
wherein the control unit is configured to
determine, based on a first image imaged by the imaging unit during movement of the harvesting device, whether fruit is present,
stop the movement of the harvesting device in a case of determining that the fruit is present, and determine whether target fruit to be harvested is present in the fruit, and
control the end effector so as to harvest the target fruit in a case of determining that the target fruit is present.
